(19) United States
(12) Patent Application Publication
(10) Pub. No.: US 2025/0176554 A1
(43) Pub. Date: Jun. 5, 2025

(54) NON-TOXIC FUMIGATION METHOD IN WHICH OZONE SYNERGIZE WITH CARBON DIOXIDE

(71) Applicant: KAI-NENG HWANG, TAINAN CITY (TW)

(72) Inventors: KAI-NENG HWANG, TAINAN CITY (TW); WAN-JU CHIU, TAINAN CITY (TW)

(73) Assignee: KAI-NENG WANG, TAINAN CITY (TW)

(21) Appl. No.: 19/048,925

(22) Filed: Feb. 9, 2025

Related U.S. Application Data
(63) Continuation of application No. PCT/CN2023/092900, filed on May 9, 2023.

(30) Foreign Application Priority Data
Aug. 9, 2022 (CN) 202210947558

(51) Int. Cl. A01N 59/04; A01N 59/00

(52) U.S. Cl. CPC A01N 59/04; A01N 59/00

(57) ABSTRACT

The present disclosure provides a non-toxic fumigation method using ozone and carbon dioxide, comprising the steps of placing a pest control object into the fumigation chamber. After the fumigation chamber is closed, the chamber is vacuumed to 0.2 bar-0.9 bar and maintained at this lower pressure for a first period of time. Ozone at a concentration ranging from 40 ppm to 160 ppm is introduced into the fumigation chamber until the pressure reaches 1.0-1.7 bar, and fumigation is carried out for 3-20 minutes. The chamber is vacuumed again to 0.2-0.9 bar, maintaining this low pressure for a second period of time. High-concentration carbon dioxide is then introduced into the fumigation chamber until the pressure reaches 1.0-1.7 bar, and fumigation is performed for 10-30 minutes. After completing the pest control process, the chamber is restored to atmospheric pressure, and the tested objects are removed.

### TECHNICAL FIELD

The present disclosure relates to a non-toxic pest control method using ozone and carbon dioxide.

### BACKGROUND

A plurality of fumigation gas is used for pest control. However, most of the fumigation gas, are toxic and even carcinogenic, such as methyl bromide, ethylene oxide, hydrogen cyanide and phosphine. In recent years, eco friendly and non-toxic gases has been proposed. For instance, carbon dioxide (CO₂) is applied to pest control, however simply using carbon dioxide takes a long time to effectively control pests. Goerke et al. reported that 10% CO₂ applied in greenhouses required one week to achieve minimal pest control effects (K. Goerke et al., Response of aphids and greenhouse plants to pesticidal concentrations of carbon dioxide, J. Plant Dis. Prot., 2005, 112(5), 50). Similarly, Wang et. al. demonstrated that asparagus treated with 60% CO₂ required more than 48 hours to achieve minimal pest control (L. X. Wang et al., Effect of high CO₂ treatment and MA packing on sensory quality and physiological-biochemical characteristics of green asparagus during postharvest storage, Horticulturae, 2020, 6, 84). Navarro's method involved vacuum pumping and then introducing 60% CO₂ under normal temperature and normal pressure, this process takes at least 16 hours to achieve 89% mortality of mite eggs (S. Navarro et al., Integrated storage pest control method using vacuum or CO₂ in a transportable system, IOBC Bulletin, 2002, 25(3), 207). Sadeghi et al. found that using CO₂ under 0.5 times atmospheric pressure required over 24 hours to kill 90% of pests (G. R. Sadeghi et al., High-pressure carbon dioxide use to control dried apricot pests, Foods, 2021, 10, 1190). Shima et al. employed pressurized CO₂ with a pressure ranged from 5 times to 15 times of the standard atmospheric pressure, which requires at least 1.8 days to kill most of the pests (S. H. Shima et al., Comparative effect of CO₂ under modified temperature and pressure conditions on adults and larvae of the red flour beetle, Coleopterist Bulletin, 2020, 74(1), 127). Serrani reported that CO₂ with 1.8 times of the standard atmospheric pressure requires at least 120 minutes to achieve the minimal pest control (Serrani et al., Industrial application of carbon dioxide and high pressure as method to perform pest control on foodstuff raw materials, Adv Agri Hort Ento, 2020,3,38). These studies consistently show that CO₂ fumigation, regardless of pressure, requires at least 2 hours for effective pest control.

Ozone (O₃), as an eco friendly and non-toxic gas, has also been explored for pest control fumigation. However, Pandiselvam et al. highlighted challenges in scaling up ozone applications due to its strong oxidative properties and potential to cause product damage (Review of ozone applications in food processing, J. Food Sci.).

Recently, a combination of O₃ and CO₂ has been proposed for pest control. Goerke et al. reported that such a mixture required over seven days to be effective (Response of aphids and greenhouse plants to pesticidal concentrations of carbon dioxide, J. Plant Dis. Prot., 2005, 112(5), 508). Similarly, Sadeghi et al. found that the combination took at least 24 hours to achieve minimal pest control effects (Combined effect of ozone mixed with CO₂ on the mortality of five stored product pests, Egypt Acad. J. Biol. Sci., 2011, 4(2), 9).

While the combination of O₃ and CO₂ demonstrates improved efficacy, but it remains limited to small spaces with diameters less than two meters due to the constraints of vacuum or pressure-resistant equipment. Furthermore, the reduced partial pressures of O₃ and CO₂ in these combinations can interfere with pest control efficiency.

The mechanism of ozone involves disrupting unsaturated fatty acids, proteins, and polysaccharides on cell membranes, altering permeability and ultimately causing cell death (R. K. Sekhon et al., Effect of CO₂ and O₃ treatment on the volatile composition and sensory quality of dry-cured ham, J. Food Sci., 2010, 75(5), 452; L. R. Beuchat, Surface disinfection of raw produce, Dairy Food Environ. Sanit., 1991, 12, 1, 6).

In contrast, carbon dioxide affects the respiratory system, ATP production, and energy metabolism, leading to mortality. It also reduces NADPH enzyme activity and is effective at controlling pests at all life stages, including eggs ((R Tsao et al., Glucosinolate breakdown products as insect fumigation and their effect on carbon sioxide emission of insects, BioMed Central Ecol, 2002,2,5, YU Cao et al., Role Modified atmosphere in pest control and mechanism of its effect on insect, Front Physiol, 2019,10, 206). These two gases operate via entirely different mechanisms, good for nontoxic fumigation but no synergism effect was ever found.

### SUMMARY

The present disclosure addresses the need for a non-toxic, highly efficient, and rapid pest control method that utilizes a synergistic effect between ozone (O₃) and carbon dioxide (CO₂). This method not only ensures effective pest elimination but also minimizes oxidative damage caused by ozone to treated objects and equipment. Additionally, it requires only general-strength equipment, making it widely applicable across various settings.

### TECHNICAL SOLUTIONS

The present disclosure is achieved by the following solutions.

A non-toxic pest control method, comprising the following steps:
Step 1: Placing the object requiring pest control into a fumigation chamber.
Step 2: Sealing the fumigation chamber and reducing the internal pressure to 0.2-0.9 bar, maintaining this low pressure for a predetermined duration.
Step 3: Introducing ozone at a concentration of 40-160 ppm into the chamber until the pressure reaches 1.0-1.7 bar, then maintaining this condition for 3-20 minutes.
Step 4: Expelling the gas from the chamber, reducing the pressure again to 0.2-0.9 bar, and maintaining this condition for another period.
Step 5: Introducing high-concentration carbon dioxide (>99.5%) into the chamber until the pressure reaches 1.0-1.7 bar, maintaining this pressure for 10-30 minutes.
Step 6: Releasing the gases, restoring the chamber to atmospheric pressure, and removing the treated objects.

Furthermore, in Step 2, after sealing the chamber, the pressure is reduced to 0.2-0.9 bar and maintained for 1.5-2.5 minutes while simultaneously vibrating the chamber.

Furthermore, in Step 3, the ozone is introduced from the bottom of the fumigation chamber.

Furthermore, in Step 4, the chamber pressure is reduced to 0.2-0.9 bar and maintained for 1.5-2.5 minutes.

Furthermore, in Step 5, carbon dioxide (>99.5%) is introduced from the bottom of the fumigation chamber.

Furthermore, in Steps 2 and 4, the pressure within the chamber is maintained in the range of 0.3-0.7 bar.

Furthermore, the ozone with a humidity ranged from 5% RH to 95% RH is introduced into the fumigation chamber.

Furthermore, the carbon dioxide with a humidity ranged from 5% RH to 95% RH is introduced into the fumigation chamber.

Furthermore, the method is applicable for eliminating living organisms that rely on a respiratory system for survival.

### BENEFICIAL EFFECTS

The present disclosure has the following advantages.

This method utilizes ozone and carbon dioxide in a two-stage fumigation process, leveraging their synergistic effect to enhance pest control efficacy. First, ozone disrupts the lipid membranes of the pests' respiratory systems, increasing their permeability. Then, high-concentration carbon dioxide is introduced, further enhancing pest mortality. This synergistic mechanism achieves 100% pest control within just 20 minutes. Compared to conventional methods, this process is significantly more efficient while minimizing ozone exposure, thereby reducing potential damage to treated products and fumigation equipment.

Additionally, since the system operates under moderate pressure conditions, it prevents damage to pressure-sensitive objects, such as fruits. Furthermore, the method allows for the use of fumigation equipment with standard structural strength but high performance, enabling scalability. Even large fumigation chambers capable of processing entire shipping containers can be utilized, making this method widely applicable across various industries.

### DETAILED DESCRIPTION OF THE EMBODIMENTS

The present disclosure relates to a non-toxic pest control fumigation through a synergism effect of ozone to carbon dioxide, and the method comprises the following steps:
Step 1: Placing the pest control object into the fumigation chamber;
Step 2: After the fumigation chamber is closed, vacuuming the chamber till 0.2 bar-0.9 bar, then maintaining this lower pressure for a first period of time;
Step 3: Introducing ozone at a concentration ranging from 40 ppm to 160 ppm to the fumigation chamber until 1.0-1.7 bar, and fumigating for 3-20 minutes;
Step 4: Exhausting the gas from the fumigation chamber, then vacuuming it to 0.2-0.9 bar, and maintaining this lower pressure for a second period of time;
Step 5: Introducing high-concentration carbon dioxide into the fumigation chamber until 1.0-1.7 bar, and fumigating for 10-30 minutes;
Step 6: after the above pest control steps, exhausting the gases from the fumigation chamber and restored the chamber to atmospheric pressure, then removing the tested objects.

Preferably, in Step 2, after the fumigation chamber been closed, vacuuming to 0.2 bar-0.9 bar, then maintaining this pressure for 1.5-2.5 minutes and vibrating the fumigation chamber at the same time.

Preferably, in Step 3, the ozone is introduced from the bottom of the fumigation chamber.

Preferably, in Step 4, vacuuming the fumigation chamber to 0.2-0.9 bar, and maintaining this low pressure for 1.5-2.5 minutes.

Preferably, in Step 5, carbon dioxide with a concentration equal to or higher than 99.5% is introduced from the bottom of the fumigation chamber.

Preferably, in Step 2 and Step 4, the pressure of the fumigation chamber ranges from 0.3 bar to 0.7 bar.

Preferably, ozone with a humidity ranging from 5% RH to 95% RH is introduced into the fumigation chamber.

Preferably, carbon dioxide with a humidity ranging from 5% RH to 95% RH is introduced into the fumigation chamber.

Preferably, the method is applied to eliminate organisms with respiratory system or respiratory organs.

The technical solution of the present disclosure will be clearly and completely described below in conjunction with specific embodiments. Based on the embodiments of the present disclosure, all other embodiments obtained by those of ordinary skill in the art without creative work should be considered as falling within the scope of protection of the present disclosure. If specific conditions are not specified in the embodiments, they are carried out according to conventional conditions or conditions recommended by the manufacturer. If the manufacturer is not specified for the reagents or instruments used, they are all conventional products that are commercially available.

The method of the present disclosure can be applied to organisms with respirators or respiratory organs and their eggs. In the following tests, coccids pests and their eggs are used to carry out the experiments. Since coccids pests or other organisms that have respiratory organs for gas exchange, the surface of their respiratory organs is moist and watery, so ozone operation does not require special humidification. When the pest control object requires a humidified environment, ozone and carbon dioxide can be humidified to a suitable degree before being input into the fumigation chamber.

### Embodiment 1

A non-toxic pest control method through the synergistic effect of ozone and carbon dioxide comprises the following steps.

Step 1: Placing the pest control object into a sample bottle, which contains coccid insects, and sealing the sample bottle with a pore size of 10 um filter membrane. This configuration simulates the environment of insects or other creatures hiding deep inside fruits, within stems, or shielded by stacked fruit packages (this test was also validated using stacked sugar apples and wax apples, yielding similar results). The sample is then placed in a fumigation chamber.

Step 2: After closing the fumigation chamber, vacuuming the chamber to 0.2 bar-0.9 bar, then maintaining this lower pressure for about 2 minutes to confirm that the fumigation chamber is well sealed.

Step 3: Introducing ozone at a concentration ranging from 40 ppm to 160 ppm into the fumigation chamber until 1.0-1.7 bar, and fumigating for 3-20 minutes.

Step 4: Exhausting the gas from the fumigation chamber, then vacuuming it to 0.2-0.9 bar, and maintaining this low pressure for about 2 minutes.

Step 5: Introducing high-concentration carbon dioxide into the fumigation chamber until 1.0-1.7 bar, fumigating for 10-30 minutes.

Step 6: After the above pest control steps, exhausting the gases from the fumigation chamber and restoring the chamber to atmospheric pressure, then removing the tested objects.

Step 7: Spraying 0.5 wt % methylene blue aqueous solution (light blue) or 0.05 wt % neutral red staining solution (light red) onto the insects and waiting for 60 minutes. Well-stained insects indicate death. All values are expressed as mean±SD. ANOVA or other appropriate statistical analysis methods were used, with P<0.05 indicating a significant difference.

### Embodiment 2: Relationship Between Ozone Concentration and Pest-Controlling Efficacy

Using the same method as Embodiment 1, except that the concentration of the introduced ozone is adjusted (ranging from 40 ppm to 160 ppm). The pressure of the fumigation chamber in Step 2 is about 0.3 bar; in Step 3, it is about 1.3 bar, with the process lasting 5 minutes; in Step 4, it is about 0.3 bar; and in Step 5, the pressure is 1.3 bar, with the process lasting 15 minutes. The results of the relationship between ozone concentration and pest-controlling efficacy are shown in Table 1 below:

TABLE 1
The effect of ozone

| | ozone | | | | |
|---|---|---|---|---|---|
| lethal rate | 40 ppm | 70 ppm | 100 ppm | 130 ppm | 160 ppm |
| Pseudococcidae (%) | 81 ± 11 | 93 ± 7 | 100 ± 0 | 100 ± 0 | 100 ± 0 |
| Icerya purchasi (%) | 76 ± 10 | 98 ± 3 | 100 ± 0 | 100 ± 0 | 100 ± 0 |

As shown in Table 1, using ozone at a concentration above 70 ppm can effectively eliminate the insects. (When the ozone concentration is 70 ppm, all insects were dead 90 minutes after the treatment in Step 3, with the lethal rate remaining 100%.)

### Embodiment 3: Relationship Between Ozone Pressure and Pest-Controlling Efficacy

Using the same method as Embodiment 2, except that the evacuation pressure in Step 2 is adjusted (ranging from 0.2 bar to 0.9 bar); the concentration of the introduced ozone is approximately 70 ppm, and other parameters remain the same as those in Embodiment 2. The results of the relationship between ozone pressure and pest-controlling efficacy are shown in Table 2 below.

TABLE 2
The effect of vacuum pressure

| | Vacuumed pressure (bar) | | | | | |
|---|---|---|---|---|---|---|
| Lethal rate | 0.2 | 0.3 | 0.4 | 0.5 | 0.6 | 0.9 |
| Pseudococcidae | 100 ± 0 | 91 ± 5 | 82 ± 10 | 71 ± 13 | 52 ± 14 | 30 ± 17 |
| (%) | | | | | | |
| Icerya purchase | 100 ± 0 | 96 ± 3 | 85 ± 12 | 68 ± 17 | 48 ± 16 | 37 ± 18 |
| (%) | | | | | | |

As shown in Table 2, in Step 2, when the vacuum pressure of the fumigation chamber is approximately 0.5 bar, 70 ppm ozone effectively eliminated the insects. However, for complete elimination, a 0.2 bar vacuum pressure is preferred. (When the vacuum pressure is 0.4 or 0.5 bar, after 90 minutes of ozone treatment, the final lethal rate remained 100%.) It can be concluded that the lower the vacuum pressure in Step 2, the higher the pest control efficiency. The tests conducted at vacuum pressures of 0.4 or 0.5 bar revealed that the respiratory organs of insects subjected to fumigation were severely damaged, leading to rapid mortality. Based on these findings, we conclude that a vacuum pressure of 0.3 bar should be used as the standard for the remaining tests.

### Embodiment 4: Ozone Treatment Time and Pest-Controlling Efficacy

Using the same method as Embodiment 2, except that the ozone treatment duration in Step 2 is adjusted (ranging from 3 to 30 minutes); the concentration of the introduced ozone is 70 ppm, and ozone is introduced until the pressure reaches 1.0 bar. Other parameters remain the same as those in Embodiment 2. The results of the relationship between ozone treatment duration and pest-controlling efficacy are shown in Table 3 below.

TABLE 3
The effect of ozone treatment

| | Ozone (min) | | | | | |
|---|---|---|---|---|---|---|
| Lethal rate | 3 | 5 | 10 | 15 | 20 | 30 |
| Pseudococcidae | 61 ± 16 | 71 ± 10 | 91 ± 7 | 100 ± 0 | 100 ± 0 | 100 ± 0 |
| (%) | | | | | | |
| Icerya purchasi | 64 ± 14 | 68 ± 9 | 87 ± 9 | 100 ± 1 | 100 ± 0 | 100 ± 0 |
| (%) | | | | | | |

Table 3 shows that by setting the evacuation pressure to approximately 0.3 bar in Step 2 and inputting ozone until the pressure reaches 1.0 bar, it only takes 5 minutes to effectively disrupt the pest's respiratory system or even kill it when the ozone concentration is 70 ppm. Additionally, 5 minutes of dry ozone exposure has a limited oxidative effect on objects or equipment.

### Embodiment 5: Pest-Controlling Efficacy of Ozone and Carbon Dioxide

Using the same method as Embodiment 1, except that the treatment period of carbon dioxide is adjusted to 10-50 minutes. The evacuation pressure in the fumigation chamber in Step 2 is 0.3 bar. In Step 3, the pressure after the ozone input is controlled within 1.0-1.4 bar, and the pest-control treatment is conducted for 5 minutes. In Step 4, the fumigation chamber is evacuated to 0.3 bar. In Step 5, the pressure after the input of carbon dioxide (99.5% concentration) is controlled at 1.4 bar, and the pest-control treatment is conducted for 10-50 minutes.

The results of the pest-control efficiency of ozone at a pressure of 1.0 bar in combination with carbon dioxide are shown in Table 4 below.

TABLE 4
The effect of carbon dioxide treatment

| | CO₂ (min) | | | | |
|---|---|---|---|---|---|
| Lethal rate | 10 | 15 | 20 | 30 | 40 |
| Pseudococcidae (%) | 81 ± 6 | 91 ± 8 | 100 ± 1 | 100 ± 0 | 100 ± 0 |
| Icerya purchasi (%) | 72 ± 11 | 88 ± 11 | 97 ± 4 | 100 ± 0 | 100 ± 0 |

The results of the pest-control efficiency of ozone at a pressure of 1.4 bar in combination with carbon dioxide are shown in Table 5 below.

TABLE 5

| | CO₂ (min) | | | | |
|---|---|---|---|---|---|
| Lethal rate | 10 | 15 | 20 | 30 | 40 |
| Pseudococcidae (%) | 89 ± 8 | 100 ± 1 | 100 ± 0 | 100 ± 0 | 100 ± 0 |
| Icerya purchasi (%) | 92 ± 11 | 100 ± 0 | 100 ± 0 | 100 ± 0 | 100 ± 0 |

This experiment shows that even if the ozone exposure time is reduced to 5 minutes, ozone at a pressure of 1.0 bar, in synergy with carbon dioxide, can completely kill the pests in about 30 minutes. If the ozone pressure is increased to 1.4 bar, the pests can be completely killed in 15 minutes (there is no difference in mortality between groups, P>0.05).

Using the same experimental conditions as Embodiment 5, when the ozone pressure is 1.4 bar, silkworm eggs were used for testing. Carbon dioxide was introduced for 20 minutes, and none of the silkworm eggs in the experimental group hatched. This experiment indicates that ozone can also damage silkworm eggs, allowing carbon dioxide to penetrate the eggs or accumulate in the air cells, thereby disrupting the hatching process.

In summary, the method of the present disclosure can also be used to effectively kill other organisms with respiratory systems or respiratory organs, such as mice, cockroaches, ants, spiders, beetles, horseflies, geckos, silkworms, and pest eggs, without toxicity.

It was found that the surface of coccid pests has a waxy layer with hydrophobic properties, making it resistant to water-based reagents. However, after ozone treatment, the water solubility and permeability of coccid pests increase. As a result, dead coccid pests treated with ozone are easily stained by water-based methylene blue aqueous solution, neutral red dye, and other dyes. Thus, staining can serve as an indicator of whether the pests are dead. Meanwhile, it was found that ozone-treated coccid pests exhibit increased water solubility and permeability, meaning their water resistance is significantly reduced. Pests with lower water resistance are more sensitive to carbon dioxide, and the pest-controlling efficiency of carbon dioxide is influenced by its initial concentration.

Therefore, the present disclosure proposes a two-stage rapid pest-control solution, in which ozone treatment is firstly conducted to disrupt the respiratory tract of the pests and increase hydrophilic permeability, and then high-concentration carbon dioxide is input to kill the pests rapidly. Additionally, by applying moderate pressure reduction measures (i.e., first evacuating to 0.3-0.7 bar) and then introducing gas at a moderately high pressure (i.e., ozone or carbon dioxide at 1.1-1.7 bar), it becomes easier to manufacture medium-pressure fumigation equipment. Furthermore, a pressure-resistant chamber can be built with a diameter exceeding 4 meters (without length limitations). The pressure reduction step solves the issue of gases struggling to penetrate gaps, while the pressure increase step addresses insufficient gas partial pressure. For example, a chamber designed to withstand moderate pressure reduction (e.g., capable of handling a pressure of 0.3 bar) can also naturally withstand moderate high pressure (e.g., up to 1.7 bar). The pressure difference between the reduced pressure and the increased pressure is 1.4 bar.

According to the method of the present disclosure, a short ozone treatment (minimum 5 minutes) is first conducted in a reduced-pressure environment (0.3-0.7 bar), followed by the introduction of carbon dioxide at 1.1-1.7 bar. This approach reduces oxidative damage to objects and equipment caused by ozone exposure, while the lipid-destroying properties of ozone enhance sensitivity to carbon dioxide. Additionally, the pressure difference between the low-pressure and high-pressure stages is 1 bar (e.g., 0.3-1.3 bar), which is equivalent to applying one atmosphere (1.0 bar) of pest-control gas with a higher concentration. Thus, even equipment designed for reduced pressure can achieve effects similar to that of normal-pressure or vacuum equipment (e.g., 1.7-0.3 bar=1.4 bar), reducing the structural strength and performance requirements for the chamber equipment.

As a result, the present disclosure enables simultaneous operation of ozone and carbon dioxide systems, integrating two pest-control gases with different mechanisms into a two-stage, non-toxic fumigation solution. First, the ozone treatment is conducted to damage the respiratory tract of the pests and increase hydrophilic permeability, then high-concentration carbon dioxide (with increased pressure) is introduced. These two gases work together to kill pests more efficiently and quickly, achieving 100% pest elimination within just 20 minutes—significantly outperforming conventional methods. Furthermore, since the entire system requires only moderate pressure reduction, its structure is simpler, and there are fewer requirements for equipment strength and performance. Thus, the fumigation chamber can be larger in size, and even entire shipping containers can be placed within the chamber. Container transportation is the most common method of shipping goods worldwide, making in-container pest fumigation the most efficient and economical method for high-density product disinfestation.

Although several embodiments of the present disclosure have been described above, those skilled in the art should understand that these embodiments are for illustrative purposes only and do not limit the scope of the present disclosure. Equivalent modifications and changes made by those skilled in the art, in accordance with the principles of the present disclosure, should be considered within the scope of the appended claims.

What is claimed is:

1. A non-toxic pest control method, comprising the following steps:
Step 1: Placing a pest control object into a fumigation chamber.
Step 2: After the fumigation chamber is closed, vacuuming the fumigation chamber to 0.2 bar-0.9 bar, then maintaining this lower pressure for a first period of time.
Step 3: Introducing ozone at a concentration ranging from 40 ppm to 160 ppm into the fumigation chamber until 1.0-1.7 bar, and maintaining it for 3-20 minutes.
Step 4: Exhausting the gas from the fumigation chamber, then vacuuming it to 0.2-0.9 bar, and maintaining this low pressure for a second period of time.
Step 5: Introducing high-concentration carbon dioxide into the fumigation chamber until 1.0-1.7 bar, and maintaining this pressure for 10-30 minutes.
Step 6: After the above pest control steps, exhausting the gases from the fumigation chamber and restoring the chamber to atmospheric pressure, then removing the tested objects.

2. The non-toxic pest control method of claim 1, wherein in Step 2, after the fumigation chamber is closed, it is vacuumed to 0.2 bar-0.9 bar, then this pressure is maintained for 1.5-2.5 minutes while vibrating the fumigation chamber at the same time.

3. The non-toxic pest control method of claim 1, wherein in Step 3, ozone is introduced from the bottom of the fumigation chamber.

4. The non-toxic pest control method of claim 1, wherein in Step 4, the fumigation chamber is vacuumed to 0.2-0.9 bar, and this low pressure is maintained for 1.5-2.5 minutes.

5. The non-toxic pest control method of claim 1, wherein in Step 5, carbon dioxide with a concentration of 99.5% or higher is introduced from the bottom of the fumigation chamber.

6. The non-toxic pest control method of claim 1, wherein in Steps 2 and 4, the pressure of the fumigation chamber ranges from 0.3 bar to 0.7 bar.

7. The non-toxic pest control method of claim 1, wherein ozone with a humidity ranging from 5% RH to 95% RH is introduced into the fumigation chamber.

8. The non-toxic pest control method of claim 1, wherein carbon dioxide with a humidity ranging from 5% RH to 95% RH is introduced into the fumigation chamber.

9. The non-toxic pest control method of claim 1, wherein the method is applied to eliminate organisms with a respiratory system or respiratory organs.
